(19) United States
(12) Patent Application Publication
(10) Pub. No.: US 2010/0009211 A1
(43) Pub. Date: Jan. 14, 2010

(54) WELDING STRUCTURE AND KEYBOARD USING THE SAME

(75) Inventor: LEI-LUNG TSAI, Yilan County (TW)

Correspondence Address: WPAT, PC;INTELLECTUAL PROPERTY ATTORNEYS, 7225 BEVERLY ST., ANNANDALE, VA, 22003, US

(73) Assignee: DARFON ELECTRONICS CORP., Taoyuan (TW)

(21) Appl. No.: 12/490,663

(22) Filed: Jun. 24, 2009

(30) Foreign Application Priority Data
Jul. 11, 2008 (TW) 097126339

(51) Int. Cl. B32B 3/10; B32B 15/00

(52) U.S. Cl. 428/596

(57) ABSTRACT

A welding structure for soldering to a metal piece, comprising: a frame and at least an insert. The frame is configured with at least a welded portion having at least a hole formed thereat, provided for receiving the insert while allowing the insert to protrude out therefrom. The frame, being used as a second shell, is designed to mate with a first shell. The first shell, being made of the material as the insert, is formed with a plurality of openings and the second shell is provided for a plurality of press-key modules to disposed thereon at positions corresponding to the plural openings. As the first shell and the second shell is jointed by soldering the first shell and the welded portions of the second shell to the insert, the structure integrality of the joined structure can be very satisfactory since the joint strength between the two shells is improved.

### FIELD OF THE INVENTION

The present invention relates to a welding structure, and more particularly, to a welding structure used for enhancing the weldability between two shells by the use of an insert embedded on its welded portion as the insert is made of the same metal used for forming the welding parts of the two shells, and thus increasing the structure integrality of a keyboard as the keyboard is the joined structure of the two shells having a plurality of press-key modules sandwiched therebetween.

### BACKGROUND OF THE INVENTION

For those skilled in the art of welding technology, to join two pieces made of the same material by welding is much each than to join two pieces of different materials by welding. However, along with the expanding application scope of welding, there are more and more applications requiring joining two pieces of different materials by welding. Moreover, even for welding pieces made of the same material, the welding effect might not be satisfactory if the melting points of the two pieces to be soldered are far from each other.

Recently, the keyboards are manufactured to be more and more smaller and slimmer but with sufficient strength for maintaining structural integrality. Accordingly, the keyboards are usually made from a stainless frame with aluminum or plastic cover while the frame and the cover, being made of different materials, are usually jointed together by screwing or gluing. Those conventional methods for keyboard assembling not only can be very complex, but also might not be able to form a joint structure with sufficient structural strength. Nevertheless, although there may be some keyboards that are assembled by welding, they still suffer poor structural strength since the weldability between pieces made of different materials is poor.

### SUMMARY OF THE INVENTION

In view of the disadvantages of prior art, the object of the present invention is to provide a welding structure capable of enhancing the weldability between pieces made of different materials.

To achieve the above object, the present invention provides a welding structure for soldering to a metal piece, which comprises: a frame and at least an insert. The frame is configured with at least a welded portion having at least a hole formed thereat that is provided for receiving the insert while allowing the insert to protrude out from the surface of the welded portion of the frame. The insert is made of a material the same as that of the metal piece with which it is adapted to be soldered to. The frame, being used as a second shell for mating with a first shell and made of the material as the insert, is formed with a plurality of openings and corresponding to that the second shell is provided for a plurality of press-key modules to disposed thereon at positions corresponding to the plural openings. The first shell and the second shell is jointed by soldering the first shell directly and the welded portions of the second shell respectively to the insert.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a sectional view of a welding structure according to a first embodiment of the invention.

FIG. 2 and FIG. 3 are schematic diagrams showing how the welding structure of FIG. 1 is soldered to a metal piece.

FIG. 4 is a sectional view of a welding structure according to a second embodiment of the invention.

FIG. 5 and FIG. 6 are schematic diagrams showing how the welding structure of FIG. 4 is soldered to a metal piece.

FIG. 7 is a sectional view of a welding structure according to a third embodiment of the invention.

FIG. 8 is a schematic diagram showing how the welding structure of FIG. 7 is soldered to a metal piece.

FIG. 9 is a sectional view of a welding structure according to a fourth embodiment of the invention.

FIG. 10 is schematic diagram showing how the welding structure of FIG. 9 is soldered to a metal piece.

FIG. 11 and FIG. 12 are schematic diagrams showing how the shells of a keyboard is assembled using a welding structure of the invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

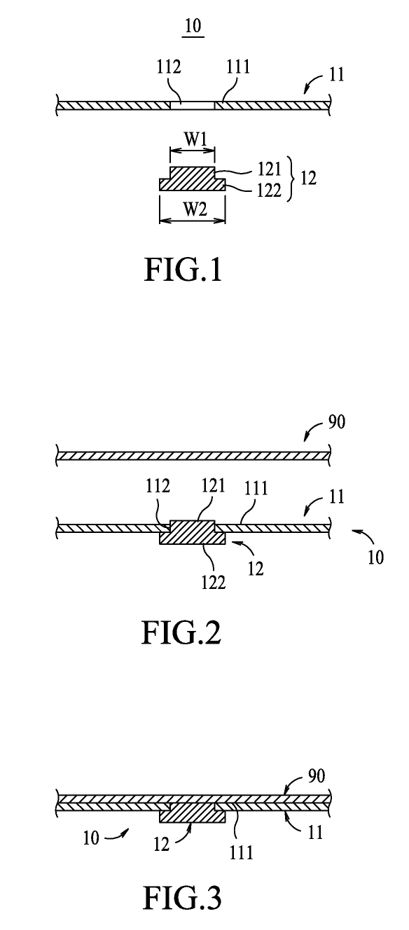

Please refer to FIG. 1, which is a sectional view of a welding structure according to a first embodiment of the invention. The welding structure 10 comprises a frame 11 and an insert 12, in which the frame is configured with at least a welded portion 111 having at least a hole 112 formed thereat; and the insert 12 is comprised of a wedge 121 for insetting into the hole 112 and a pad 122 connecting to the wedge 121. It is noted that the circumference W2 of the pad 122 is larger than the circumference W1 of the wedge 121. As shown in FIG. 2, after insetting the wedge 121 of the insert 12 into the hole 112 of the welded portion 111 on the frame 11, the wedge 121 of the insert 12 will protrude out from the surface of the welded portion 111 while enabling the pad 122 to press against the bottom of the welded portion 111 and thus being disposed under the hole 112. Thereby, the welding structure 10 is ready to be soldered to a metal piece 90 as the insert 12 is made of a material the same as that of the metal piece 90. In FIG. 3, the metal piece is welded to the insert 12 fitted to the welded portion 111 so that the metal piece 90 can be welded to the welding structure 10 with sufficient strength as the insert 12 is made of the same material as the metal piece 90.

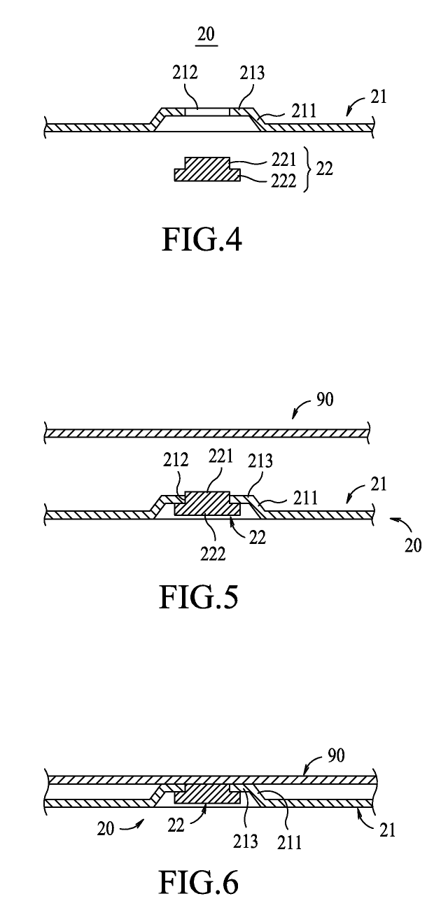

Please refer to FIG. 4, which is a sectional view of a welding structure according to a second embodiment of the invention. In this embodiment, the welding structure 20 also is comprised of a frame 21 and an insert 22, but is characterized in that: the welded portion 211 of the frame 21 is configured with a protrusion 213 provided for a hole 212 to be formed thereat. Similarly, the insert 22 is comprised of a wedge 221 for insetting into the hole 212 and a pad 222 connecting to the wedge 221. As shown in FIG. 5 and FIG. 6, after insetting the wedge 221 into the hole 212 and then engaging the protrusion 213 of the frame 21 with a metal piece 90, the insert 22 can be placed at a position for enabling the same to contact exactly with the metal piece 90. It is noted that the height of the protrusion 213 is determined according to actual requirement, and thus is not limited by any restriction.

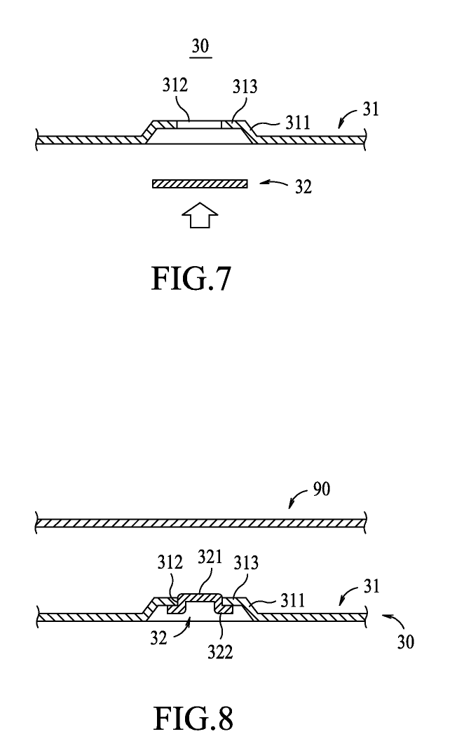

Please refer to FIG. 7, which is a sectional view of a welding structure according to a third embodiment of the invention. In this embodiment, the welding structure 30 also is comprised of a frame 31 and an insert 32 and the welded portion 311 of the frame 21 is also configured with a protrusion 313 provided for a hole 312 to be formed thereat, but is characterized in that: the insert 32, being a plate, can be riveted into the hole 312 by stamping or hot-pressing. As shown in FIG. 8, the portion of the plate 32 being fitted into the hole 312 can be used as a wedge 321 while leaving the rest of the plate outside the hole 312 to be used as a pad 322 so as to construct the welding structure 30 adapted for soldering with a metal piece 90.

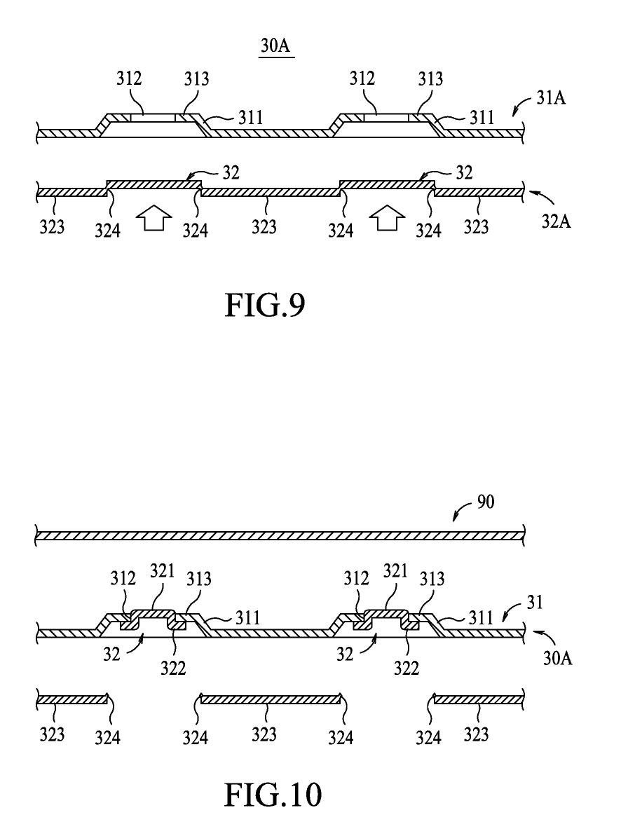

Please refer to FIG. 9, which is a sectional view of a welding structure according to a fourth embodiment of the invention. The welding structure 30A is an variation of the welding structure 30 shown in FIG. 7. In this embodiment, the welding structure 30A is comprised of a frame 31A and an insert set 32A, in which the frame 31A is configured with a plurality of welded portions 311 in a manner that each welded portion 311 is formed with a protrusion 313 having a hole formed thereat; and the insert set 32A is composed of a plurality of inserts 32 while the plural inserts 32 are interconnected with each other by the use of a connecting component 323 and arranged at positions corresponding to the holes 312 formed on the frame 31A. It is noted that each of the insert 32 is designed to be riveted into its corresponding hole 312 by stamping or hot-pressing. As shown in FIG. 10, as soon as one inserts 32 in the interconnected insert set 32A are riveted into its corresponding hole 312, the connecting component 323 will be broken for separating the insert 32 from the interconnected insert set 32A. As shown in FIG. 9, the joint 324 between the connecting component 323 and the insert 32 can be processed in advance into a state that it can be easily broken for facilitating the separation of the inserts 12 from the connecting component 323.

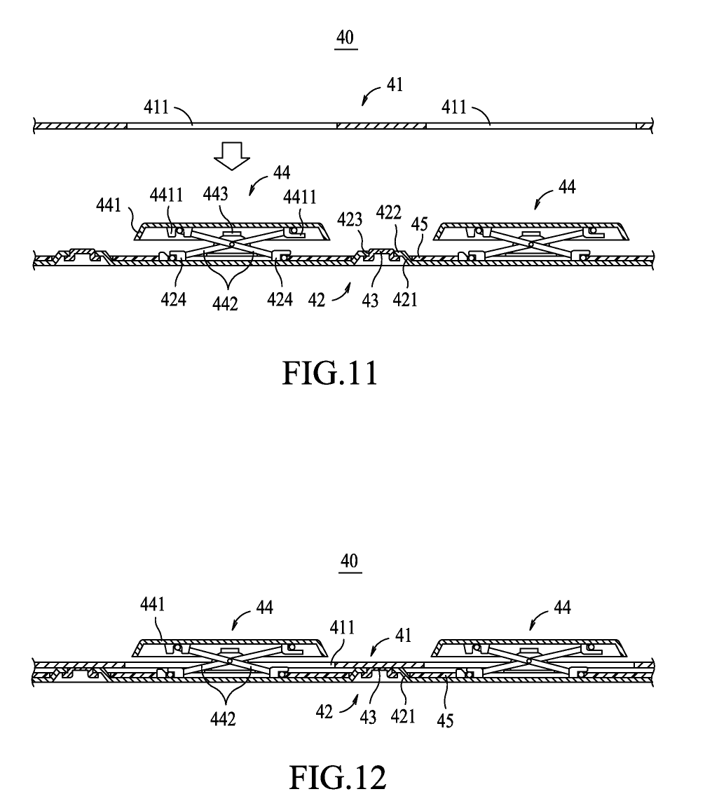

The aforesaid welding structure can all be used for constructing a keyboard, as the one shown in FIG. 11. In FIG. 11, The keyboard 40 is composed of: a first shell 41, configured with a plurality of openings 411 and made of a metal; a second shell 42, disposed under the first shell 41 while being configured with a plurality of welded portions 421, each configured with a protrusion 422 provided for a hole 423 to be formed thereat; a plurality of inserts 43, each made of the same metal as the first shell 41 and being inset into its corresponding holes 423 while allowing the same to protrude out from the surface of its corresponding welded portion 421; a thin-film circuitboard 45, disposed on the second shell 42 while being sandwiched between the first shell 41 and the second shell 42; and a plurality of press-key modules 44, each being disposed on the second shell 42, and each press-key module 44 further comprising: a keycap 441, a scissor-type supporting element 442 and an elastic member 443, being disposed at a position between its corresponding keycap 441 and the second shell 42 for providing resilience to the keycap 441 after being pressed; wherein, the plural scissor-type supporting elements 442 along with their corresponding keycaps 441 are being disposed on the second shell 42 at positions corresponding to the plural openings 411 of the first shell 41 for allowing they to be received therein and then protrude out of the first shell 41 therefrom; and top and bottom of each scissor-type supporting element 441 are pivotally connected to the second shell 42 and its corresponding keycap 441 in respective. As shown in FIG. 11, by the couplers 424, 4411 formed respectively on the second shell 42 and each keycap 441 that are provided for pivotally connecting to the top and the bottom of the scissor-type supporting element 442, the keycaps 441 can be connected to the second shell 42.

As shown in FIG. 12, after the assembling of the second shell 42, the inserts 43, the press-key modules 44 and the thin-film circuitboard is completed, the first shell 41 is then being placed to cover the second shell 42 in a manner that each supporting element 442 is received inside its corresponding opening 411 while allowing its keycap 441 to protrude out of the first shell 411 or be exposed from the opening 411. Thereafter, the first shell 41 as well as the welded portions 421 of the second shell 42 are welded to the inserts 43 for constructing a joined structure with good the structure integrality since the joint strength between the two shells is improved as the inserts 43 are made of the same material as the first shell 41.

To sum up, the present invention provides a welding structure capable of enhancing the weldability between two shells by the use of an insert embedded on its welded portion as the insert is made of the same metal used for forming the welding parts of the two shells, and thus increasing the structure integrality of a keyboard as the keyboard is the joined structure of the two shells having a plurality of press-key modules sandwiched therebetween.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A welding structure for soldering to a metal piece, comprising:
a frame, configured with at least a welded portion having at least a hole formed thereat; and
at least an insert, being made of a material the same as that of the metal piece and each being received inside the at least one hole while allowing the same to protrude out from the corresponding welded portion.

2. The welding structure of claim 1, wherein each welded portion is configured with a protrusion provided for the at least one hole to be formed thereat and used for abutting against the metal piece.

3. The welding structure of claim 1, wherein each inset further comprising:
a wedge, for insetting into the hole corresponding to the insert; and
a pad, connected to the wedge and being formed with large than the wedge in circumference.

4. The welding structure of claim 1, wherein each insert is a plate capable of being riveted into its corresponding hole.

5. The welding structure of claim 4, wherein the riveting of the insert into the corresponding hole is performed by stamping.

6. The welding structure of claim 4, wherein the riveting of the insert into the corresponding hole is performed by hot-pressing.

7. The welding structure of claim 4, wherein the frame is configured with a plurality of said welded portions each having at least one said hole formed thereat; and there is a plurality of said inserts disposed on the frame in a manner that they are interconnected with each other as a whole.

8. The welding structure of claim 7, wherein the plural inserts are adapted to be riveted respectively into their corresponding holes by stamping.

9. The welding structure of claim 7, wherein the plural inserts are adapted to be riveted respectively into their corresponding holes by hot-pressing.

10. A keyboard, comprising:
a first shell, having a plurality of openings formed thereat;
a second shell, configured with a plurality of welded portions, each having at least a hole formed thereat;
a plurality of press-key modules, disposed on the second shell at positions corresponding to the openings; and
at least an insert, being made of a material the same as that of the first shell and received inside the at least hole while allowing the same to protrude out from the surface of the corresponding welded portion;
wherein, the first shell and the second shell is jointed together by soldering the first shell directly and the welded portions of the second shell respectively to the at least one insert.

11. The keyboard of claim 10, wherein each welded portion of the second shell is configured with a protrusion provided for the at least one hole to be formed thereat and used for abutting against the first shell.

12. The keyboard of claim 10, wherein each insert further comprises:
a wedge, for insetting into the hole corresponding to the insert; and
a pad, connected to the wedge and being formed with large than the wedge in circumference.

13. The keyboard of claim 10, wherein each insert is a plate capable of being riveted into its corresponding hole.

14. The keyboard of claim 13, wherein the riveting of the insert into the corresponding hole is performed by stamping.

15. The keyboard of claim 13, wherein the riveting of the insert into the corresponding hole is performed by hot-pressing.

16. The keyboard of claim 13, further comprising:
a plurality of said inserts, formed arranged interconnecting with each other.

17. The keyboard of claim 16, wherein the plural inserts are adapted to be riveted respectively into their corresponding holes by stamping.

18. The keyboard of claim 16, wherein the plural inserts are adapted to be riveted respectively into their corresponding holes by hot-pressing.

19. The keyboard of claim 10, wherein the first shell is made of a metal.

20. The keyboard of claim 10, further comprising:
a thin-film circuitboard, sandwich between the first shell and the second shell.

21. The keyboard of claim 10, wherein each press-key module is composed of:
a keycap, arranged at a position over the second shell; and
a supporting element, capable of being fitting into its corresponding opening while connecting respectively to the second shell and the keycap.

22. The keyboard of claim 21, wherein the supporting element is a scissors-type structure; and the second shell as well as the keycap are configured with a coupler provided for the scissors-type supporting element to engaged thereto so as to connected to the second shell and the keycap.

23. The keyboard of claim 22, further comprising:
a plurality of elastic members, each being disposed at a position between its corresponding keycap and the second shell.
